(19) United States
(12) Patent Application Publication
(10) Pub. No.: US 2012/0057926 A1
(43) Pub. Date: Mar. 8, 2012

(54) APPARATUS COMPRISING A FITTING AND AN ADAPTER PLATE AND METHOD FOR PRODUCING SUCH AN APPARATUS

(76) Inventors: Frank Fassebender, Coburg (DE); Oliver Steffen, Coburg (DE); Michael Zellmann, Bischberg (DE)

(21) Appl. No.: 13/256,908

(22) PCT Filed: Mar. 10, 2010
(86) PCT No.: PCT/DE2010/000257

§ 371 Date: Sep. 28, 2011

(30) Foreign Application Priority Data
Mar. 16, 2009 (DE) 10 2009 013 881.1

(51) Int. Cl. F16C 11/04; B60N 2/22; B23K 26/20

(52) U.S. Cl. 403/66; 219/121.64

(57) ABSTRACT

An apparatus, in particular for a vehicle seat, comprising a fitting and at least one adapter plate connected with the fitting, is provided. The fitting comprises a first fitting part and a second fitting part rotatable about an axis relative to the first fitting part. The adapter plate is firmly connected with the first fitting part by means of at least one welding seam. The adapter plate includes at least one region which has a reduced wall thickness, and the welding seam is formed in the region of reduced wall thickness in the adapter plate.

### CROSS-REFERENCE TO A RELATED APPLICATION(S)

This application is a National Phase Patent Application of International Patent Application Number PCT/DE2010/000257, filed on Mar. 10, 2010, which claims priority of German Patent Application Number 10 2009 013 881.1, filed on Mar. 16, 2009.

### BACKGROUND

This invention relates to an apparatus comprising a fitting and at least one adapter plate connected with the fitting and to a method for producing such apparatus. In one configuration, the apparatus is integrated into a vehicle seat, in particular into a motor vehicle seat.

From DE 10 2007 009 172 A1 a fitting for a vehicle seat is known, which includes a first fitting part, a second fitting part and a retaining ring connecting the two fitting parts. An adapter plate is attached to the first fitting part and also to the retaining ring. By means of a welding seam the adapter plate, the first fitting part and the retaining ring all are connected with each other. For this simultaneous connection, however, a welding apparatus is required, which holds the retaining ring and the two fitting parts together in a prepositioned position. In particular, the low-backlash assembly of the fitting in axial direction requires a particular effort.

It is also disadvantageous in the known solution that a possible testing of the mere fitting (without adapter plate) is not possible, since fitting and adapter plate are mounted at the same time by the common welding seam. Correspondingly, it is not possible either to manufacture project-neutral fittings (without adapter plate) which have a distinctly lower weight and permit a higher packing density.

Further fittings for vehicle seats are known from DE 10 2004 018 744 B3, DE 20 2006 011 556 U1, EP 1 837 229 A1 and JP 2007 195868 A.

### SUMMARY

Proceeding from said prior art it is the object underlying the present invention to provide an apparatus with a fitting and an adapter plate as well as a method for producing such apparatus, which provide for an easy connection between a fitting and an adapter plate.

According to an exemplary embodiment of the invention the adapter plate includes at least one region which has a reduced wall thickness and the welding seam is formed in the region of reduced wall thickness in the adapter plate.

By realizing the welded joint in a region of reduced thickness of the adapter plate, less input of heat is required for producing the welded joint. The welding performance can be diminished due to the reduction in wall thickness. Less input of heat means less welding distortion, a low investment (i.e. a lower laser performance) and a higher welding speed, so that the connection between the adapter plate and the fitting can be provided in a simple and effective way. The apparatus according to the invention in addition allows to connect the adapter plate with the actual fitting only after the production and possibly preliminary testing. The fitting can represent a separate assembly, which can be tested and transported separately.

Welding for example is effected by means of a laser welding apparatus. In principle, however, other welding techniques can also be employed. In the case of laser welding a largely reduced input of heat is realized as compared to MAG or CMT welding (MAG=Metal-Active Gas; CMT=Cold Metal Transfer).

It should be noted that an adapter plate according to the invention with a region of reduced wall thickness can be provided for connection with the one fitting part of the fitting or for connection with the other fitting part of the fitting. Moreover, two adapter plates according to the invention can be provided, of which one is connected with the one fitting part and the other is connected with the other fitting part.

Furthermore, it should be noted that an adapter plate in the sense of the present invention can be, but need not be a part separate from the seat structure (which will be connected with the seat structure). It also lies within the scope of the invention that the adapter plate represents a seat structure element, for example of the backrest or of the seat side part.

In a preferred exemplary aspect of the invention, the adapter plate and the first fitting part include form-fit elements corresponding with each other, which allow a prepositioning of adapter plate and first fitting part relative to each other. There is formed at least one region of reduced wall thickness on a or adjacent to such a form-fit element of the adapter plate. The corresponding form-fit elements for example are formed as recesses of the adapter plate and as corresponding protrusions of the first fitting part. The wall thickness of the adapter plate is reduced adjacent to the recess.

The term “form-fit elements corresponding with each other” also includes structures which do not exactly complement each other. For example, it might also be provided that in the adapter plate a larger circular or polygonal recess is formed, which encloses a plurality of protrusions of the fitting part and thereby allows a prepositioning of adapter plate and first fitting part. The wall thickness of the adapter plate in turn would be reduced adjacent to such recess.

In one exemplary aspect it is provided that the recess is formed to be circular, and a region of reduced wall thickness adjacent to the recess is formed to be ring-shaped. Hence, a welding seam can be set in a simple way in the region of the form-fit elements corresponding with each other.

In a further exemplary aspect, a plurality of protrusions and recesses each corresponding to the same are provided as form-fit elements, so that due to the prepositioning the adapter plate and the first fitting part are completely aligned with each other and for connecting these components only welding seams must be set.

The region of reduced wall thickness for example is reduced by up to 70% as compared to the wall thickness in other regions of the adapter plate. For example, there is a reduction which amounts to 40% to 60% based on the non-reduced wall thickness. In one design variant it can be provided that in a region of reduced wall thickness the adapter plate has a wall thickness between 1.2 mm and 2.4 mm, in particular between 1.5 mm and 2 mm, whereas the wall thickness of the adapter plate otherwise has a value between 2.5 mm and 4.5 mm.

In one exemplary configuration, the welding seam which connects the adapter plate in the region of reduced wall thickness and the first fitting part with each other is an overlap seam. For this case, the assembly can be effected in a simple way and without having regard to tolerances, in that after prepositioning the mounting plate with respect to the first fitting part, the mounting plate is pressed against the fitting part and subsequently the welding seam is set. As overlap seam (through-welding seam) the welding seam penetrates both the adapter plate and at least partly the first fitting part. A cost expensive, tolerance-related fine adjustment is not required.

It can possibly be provided that the welded joint includes two overlap seams extending in parallel. For example, two overlap seams each are formed as circles concentric to each other in the region of the recesses of the adapter plate.

In a further exemplary aspect of the invention the welding seam which connects the adapter plate in the region of reduced wall thickness and the first fitting part with each other is formed as fillet weld. In this variant, the welding seam thus is placed in the flute which is present between the fitting part and the region of reduced wall thickness of the adapter plate.

The thickness of the adapter plate preferably is substantially constant in a region of reduced wall thickness, i.e. the region reduced in thickness has a constant thickness. Correspondingly, the reduction in thickness is formed as a substantially rectangular step in the adapter plate.

In a further exemplary aspect the first fitting part and a retaining ring of the fitting, which holds the first and the second fitting part together in axial direction, are connected with each other via a further welding seam, which is at least partly formed circumferential in the first fitting part. The further welding seam hence extends on the end face at the radial end of the first fitting part. By such welding seam the fitting can be protected against impurities during transport or as a result of welding splashes during attachment of the adapter plate. The preceding further laser seam in so far protects the assembly of the fitting.

The method according to an exemplary embodiment of the invention includes the following steps:
providing a fitting which comprises a first fitting part and a second fitting part rotatable about an axis relative to the first fitting part,
providing an adapter plate which includes at least one region with a reduced wall thickness,
connecting the adapter plate with the first fitting part by means of a welding seam which is formed in the region of reduced wall thickness in the adapter plate.

### BRIEF DESCRIPTION OF THE DRAWINGS

The invention will be explained in detail below by means of an exemplary embodiment with reference to the Figures of the drawing:

FIG. 1 shows a perspective side view of an exemplary embodiment of a fitting connected with an adapter plate.

FIG. 2 shows a partly sectional view of the realization of a welding seam between the adapter plate and the one fitting part in the exemplary embodiment of FIG. 1.

FIG. 3 shows a perspective sectional representation of the adapter plate of FIGS. 1 and 2.

FIG. 4 shows a partly sectional view of a design variant in which the connection between the adapter plate and the fitting part is effected by means of two parallel welding seams.

FIG. 5 shows an exemplary embodiment of a fitting which according to FIGS. 1 to 4 is connectable with an adapter plate.

### DETAILED DESCRIPTION

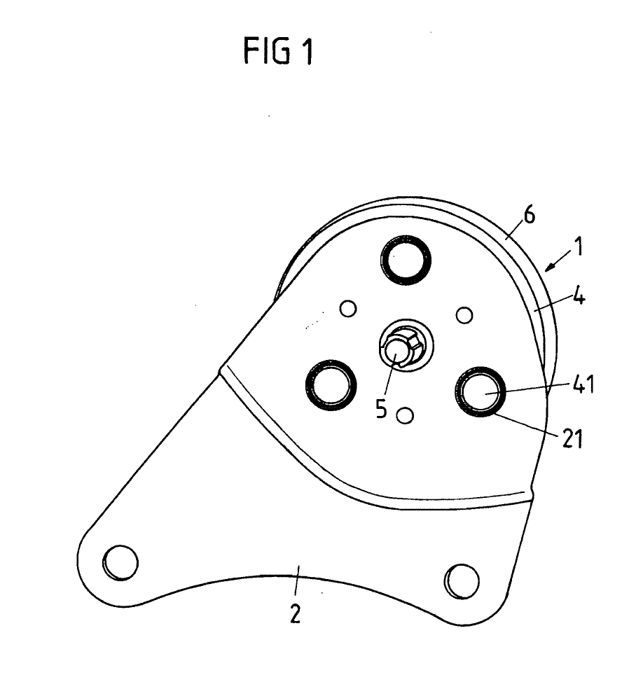

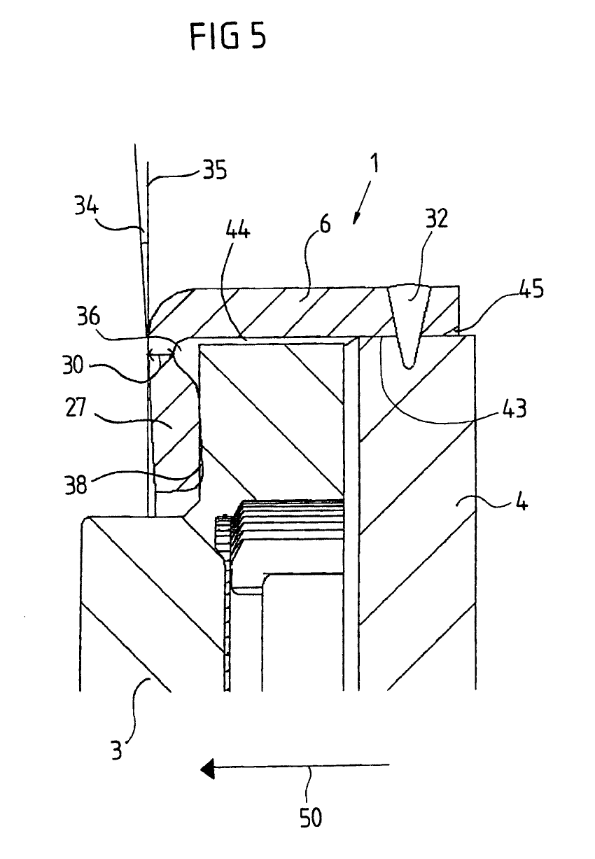

FIG. 1 shows a fitting 1 which is connected with an adapter plate 2. In a manner known per se, the fitting 1 includes a first fitting part, a second fitting part rotatable about an axis relative to the first fitting part, and a retaining ring which holds the first and the second fitting part together in axial direction. An exemplary embodiment of a fitting will be explained below with reference to FIG. 5. In the side view of FIG. 1 the first fitting part 4 and the retaining ring 6 can be seen.

In a manner yet to be explained, the first fitting part 4 is non-rotatably connected with the adapter plate 2 which is connected with the lower part of a vehicle seat and thus serves for connecting the fitting part 4 with the vehicle structure. The other fitting part is connected with the backrest of the vehicle seat. A shaft 5 is rotatable manually by means of a hand wheel or lever or by motor about the axis on which the shaft 5 is located. In so far, reference is made to the configuration of the fitting and the associated shaft as described in DE 10 2007 009 172 A1.

What is of interest in the context of the present invention is the connection of the first fitting part 4 with the adapter plate 2. For this purpose, form-fit elements corresponding with each other are formed on the one hand in the first fitting part 4 and on the other hand in the adapter plate 2. In the illustrated exemplary embodiment, but not necessarily, the form-fit elements on the one hand are circular protrusions or noses 41 formed on the first fitting part 4. On the other hand, the form-fit elements formed in the adapter plate 2 are circular recesses 21. In the illustrated exemplary embodiment, three of such noses 41 and recesses 21 are provided, which are arranged around the shaft 5 corresponding to the shape of an equilateral triangle. However, other arrangements and/or another number of form-fit elements corresponding to each other are also possible. The form-fit elements also can have another shape, for example be formed polygonal or oval instead of circular.

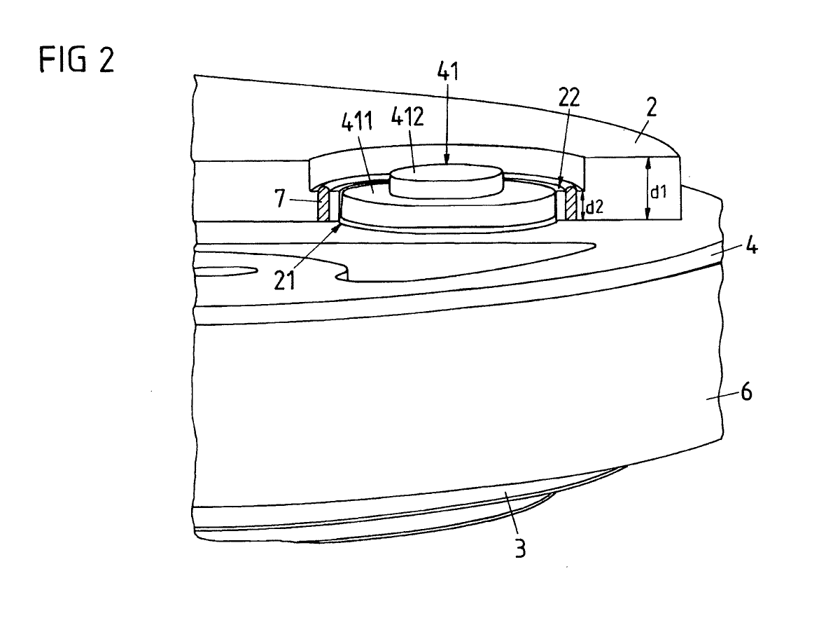

In a partly sectional perspective view, FIG. 2 shows the connection between the adapter plate 2 and the first fitting part 4 in the region of two form-fit elements 41, 21. It can be seen that the wall thickness d1 of the adapter plate 2 adjacent to the recess 21 along a ring 22 which adjoins the recess 21 is reduced to a wall thickness d2. In the region 22 of reduced wall thickness d2 a through-welding seam 7 in the form of an overlap seam is set, which extends circularly in the region 22 of reduced diameter d2, penetrates the adapter plate 2 in the region 22 of reduced wall thickness and extends down into the first fitting part 4 for connecting the adapter plate 2 with the first fitting part 4 (not shown).

The surfaces of the adapter plate 2 and of the fitting part 4 facing each other are formed to be planar, so that the two components for the welding operation are positioned directly adjacent to each other and can be pressed against each other with a minimum welding gap.

Due to the formation of the welding seam 7 in the region 22 of reduced wall thickness d2 the welding performance can be diminished due to the reduction in wall thickness. This means less welding distortion, a lower investment and a higher welding speed. The welding seam 7 preferably is provided by means of a laser welding apparatus.

The adapter plate 2 for example is formed as a punching element with a wall thickness between 2.5 and 4.5 mm. For realizing the region 22 of reduced wall thickness d2, for example a hole initially is punched into the adapter plate 2 by means of a first punch, whose size corresponds to the size of the recess 21. Subsequently, a second punch with a larger diameter is applied concentrically, which does, however, not punch out a hole, but merely reduces the wall thickness to the desired extent. The material pushed away is urged in direction of the hole provided already and protrudes into the same. Subsequently, the first punch of smaller diameter is applied again, wherein the material protruding into the hole is removed again. What remains is the desired stepping, which adjacent to the recess 21 provides a ring-shaped region of reduced wall thickness 22.

The wall thickness of the adapter plate 2 in the reduced region for example lies between 1.2 and 2.4 mm, in particular in the range between 1.5 and 2 mm. The first fitting part 4 for example has a wall thickness of 4 to 4.5 mm, wherein the protrusion 41 protrudes from the first fitting part 4 for example by 1.5 to 2 mm.

As can be seen in FIG. 2, the nose 41 has a first region of larger diameter 411, whose dimensions correspond with the dimensions of the recess 21 of the adapter plate 2 and whose height corresponds with the reduced wall thickness in the region 22 of reduced wall thickness. In addition, a centrally arranged second region 412 is provided, which protrudes further as compared to the first region 411. The nose 41 can, however, also be formed as a single step.

FIG. 2 also shows the retaining ring 6 and the second fitting part 3.

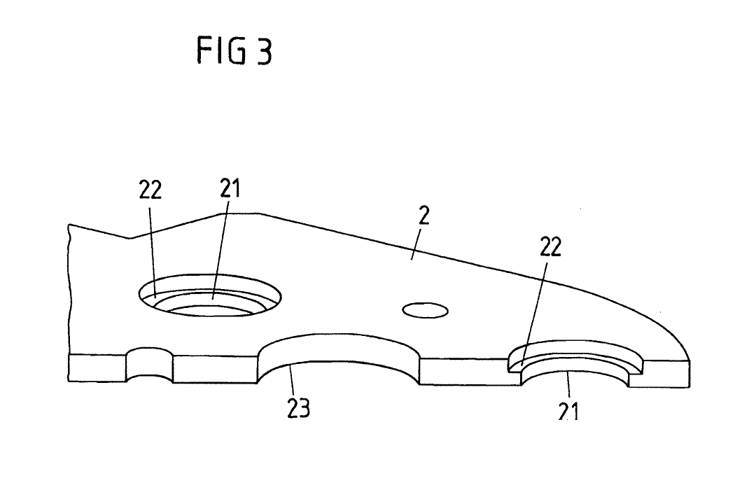

FIG. 3 shows a perspective view of a section through the adapter plate 2 in the region of a recess 21, which includes a region of reduced diameter 21, and in the region of a central recess 23 through which the shaft 5 extends.

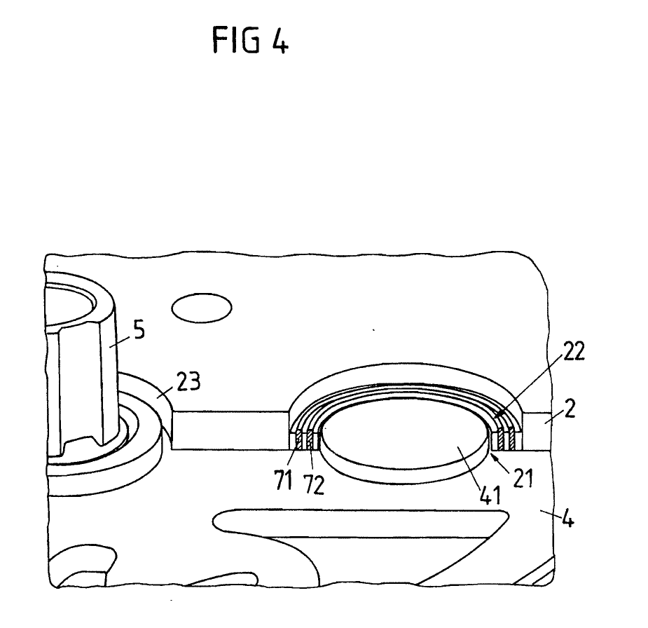

FIG. 4 shows an exemplary embodiment in which two parallel welding seams 71, 72 are realized in the region 22 of reduced diameter. This serves an optimization of strength. The two welding seams 71, 72 extend concentric and parallel to each other.

It should be noted that the connection between the adapter plate 2 and the first fitting part 4 can also be formed by means of a fillet weld instead of by means of an overlap seam.

For establishing a connection between the fitting 1 and the adapter plate 2, the fitting 1 first is produced as a separate assembly, tested for operability and possibly transported to an assembly site. Furthermore, the adapter plate 2 is provided, which includes at least one region of reduced wall thickness. The adapter plate 2 and the fitting 1 are positioned relative to each other by putting the protrusions 41 of the first fitting part 4 through the recesses 21 of the adapter plate 2. Hence, the relative position between adapter plate 2 and first fitting part 4 already is defined completely.

As explained, the surfaces of the first fitting part 4 and of the adapter plate 2 resting against each other are formed to be planar at least in the overlap region, so that the same directly rest against each other and can be welded to each other with a minimum welding gap by means of an overlap seam or alternatively by means of a fillet weld. In one design variant, two parallel welding seams are set according to the embodiment of FIG. 4.

FIG. 5 shows a cross-sectional view of a partial region of a fitting 1 which is suitable for connection with an adapter plate as shown in FIGS. 1 to 4. First of all, the first fitting part 4, the second fitting part 3 and the retaining ring 6 can be seen. The protrusions 41 of the first fitting part 4 are not shown in FIG. 5.

The fitting parts 3 and 4 are held in axial direction (along the axis of rotation 50) relative to each other by means of the retaining ring 6.

The retaining ring 6 has a planar outside surface, with respect to which a stop 27 is angled overstretched. The angle 34 of the stop 27 with respect to the radial direction is about 3% in the illustrated pretensioned condition. For adjusting defined spring elasticities, a groove 36 is incorporated in the inner shoulder of the retaining ring 6 towards the stop 27, which reduces the material of the stop 27 to a residual wall thickness 30 of about 0.8 mm and thereby provides for a desired counter force of the stop 27 against the fitting part 3.

By overstretching the stop 27 with respect to the radial direction 35, a defined contact point 38 is obtained between the stop 27 and the abutment surface 37 of the second fitting part 3. As a result of the counter force caused by the overstretched stop 27, the second fitting part 3 experiences a defined pretension with respect to the first fitting part 4. In the retaining ring 6 the second fitting part 3 can be rotated with respect to the first fitting part 4 without backlash with a predefined tension.

In the pretensioned position, the retaining ring 6 is joined to the first fitting part 4 by means of a laser weld. This is effected via a through-welding seam 32 which is made by laser welding. The through-welding seam 32 is at least partly formed at the circumference of the first fitting part 4.

In an alternative design, a circumferential fillet weld 45 instead of a through-welding seam 32 can be produced by means of laser welding or a conventional welding method between the edge of the retaining ring 6 and the first fitting part 4. Such fillet weld 45 permits greater radial tolerances between the retaining ring 6 and the first fitting part 4. In addition, higher forces can be transmitted.

To be able to easily push the retaining ring 6 over the first fitting part 4 during manufacture, a joining gap 43 is provided between the retaining ring 6 and the first fitting part 4. In case of joining by means of a fillet weld, this joining gap can have a dimension up to 0.5 mm.

The radial gap 44 necessary for moving the second fitting part 3 on the retaining ring 6 with respect to the retaining ring 6 likewise is shown in FIG. 5.

As seen from the adapter plate 2, the through-welding seam 32 or alternatively the fillet weld 41 represents a preceding laser seam of the fitting 1. The assembly which realizes the fitting 1 is protected by the preceding laser seam, for example against soiling during transport or against welding splashes caused during the connection with the adapter plate.

The invention is not limited in its design to the exemplary embodiments described above, which should merely be understood by way of example. For example, the region of reduced wall thickness can also be realized in one or more edge regions of the adapter plate and not on recesses of the adapter plate. Furthermore, recesses which are adjoined by a region of reduced wall thickness can also be formed in the adapter plate in another shape and in another number. It can also be provided that alternatively or in addition an adapter plate is provided with a region of reduced wall thickness for connecting the second fitting part with the backrest of the vehicle seat.

1-20. (canceled)

21. An apparatus, in particular for a vehicle seat, comprising a fitting and at least one adapter plate connected with the fitting, wherein
the fitting comprises a first fitting part and a second fitting part rotatable about an axis relative to the first fitting part,
the adapter plate is firmly connected with the first fitting part by means of at least one welding seam, and
the adapter plate includes at least one region which has a reduced wall thickness, and the welding seam is formed in the region of reduced wall thickness in the adapter plate.

22. The apparatus according to claim 21, wherein the adapter plate and the first fitting part include form-fit elements corresponding with each other, which allow a prepositioning of adapter plate and first fitting part relative to each other, and at least one region of reduced wall thickness is formed on a or adjacent to a form-fit element of the adapter plate.

23. The apparatus according to claim 21, wherein the adapter plate includes at least one recess and the wall thickness of the adapter plate is reduced adjacent to the recess.

24. The apparatus according to claim 23, wherein the recess is circular and a region of reduced wall thickness of the adapter plate, which adjoins the recess, is formed ring-shaped.

25. The apparatus according to claim 22, wherein on the first fitting part at least one protrusion is formed as form-fit element which corresponds with a recess of the adapter plate.

26. The apparatus according to claim 25, wherein a plurality of protrusions and a plurality of recesses each corresponding to the same are provided.

27. The apparatus according to claim 21, wherein in a region of reduced wall thickness the adapter plate has a wall thickness which is reduced by up to 70% as compared to the wall thickness in other regions of the adapter plate.

28. The apparatus according to claim 21, wherein in a region of reduced wall thickness the adapter plate has a wall thickness between 1.2 mm and 2.4 mm, in particular between 1.5 mm and 2 mm, whereas the wall thickness of the adapter plate otherwise has a value between 2.5 mm and 4.5 mm.

29. The apparatus according to claim 21, wherein the thickness of the adapter plate in the region of reduced wall thickness is substantially constant.

30. The apparatus according to claim 21, wherein the welding seam which connects the adapter plate in the region of reduced wall thickness and the first fitting part with each other is formed as overlap seam.

31. The apparatus according to claim 30, wherein the welding connection includes two overlap seams extending in parallel.

32. The apparatus according to claim 21, wherein the welding seam which connects the adapter plate in the region of reduced wall thickness and the first fitting part with each other is formed as fillet weld.

33. The apparatus according to claim 24, wherein the welding seam is formed circular.

34. The apparatus according to claim 21, wherein furthermore a retaining ring is provided, which holds the first and the second fitting part together in axial direction, wherein the first fitting part and the retaining ring are connected with each other via a further welding seam which is at least partly formed circumferential in the first fitting part.

35. The apparatus according to claim 21, wherein furthermore a retaining ring is provided, which holds the first and the second fitting part together in axial direction, wherein the retaining ring axially engages over the first fitting part and pretensions the second fitting part against the first fitting part by means of a stop angled inwards against the radial direction.

36. The apparatus according to claim 21, wherein the welding seam which connects the adapter plate with the first fitting part is a laser welding seam.

37. A method for producing an apparatus according to claim 21, with the following steps:
providing a fitting which comprises a first fitting part and a second fitting part rotatable about an axis relative to the first fitting part,
providing an adapter plate which includes at least one region with a reduced wall thickness,
connecting the adapter plate with the first fitting part by means of a welding seam which is formed in the region of reduced wall thickness in the adapter plate.

38. The method according to claim 37, wherein before connecting the adapter plate with the first fitting part the fitting is tested for operational reliability.

39. The method according to claim 37, wherein for connecting the adapter plate with the first fitting part the welding seam is formed as overlap seam or as fillet weld.

40. The method according to claim 39, wherein the welding seam is formed as double overlap seam which comprises two welding seams extending in parallel.
